(19) United States
(12) Patent Application Publication
(10) Pub. No.: US 2024/0162622 A1
(43) Pub. Date: May 16, 2024

(54) RF-Photonic Antennas and Arrays, Receivers, Transmitters, Transceivers, Components, and Related Methods

(71) Applicant: Phase Sensitive Innovations, Inc., Newark, DE (US)

(72) Inventor: Janusz Murakowski, Bear, DE (US)

(73) Assignee: Phase Sensitive Innovations, Inc., Newark, DE (US)

(21) Appl. No.: 18/370,828

(22) Filed: Sep. 20, 2023

Related U.S. Application Data
(60) Provisional application No. 63/408,426, filed on Sep. 20, 2022.

(51) Int. Cl. H01Q 15/08; H01Q 19/06

(52) U.S. Cl. CPC H01Q 15/08; H01Q 19/062

(57) ABSTRACT

Novel RF-Photonic antennas and antenna arrays, receivers, transmitters, transceivers and components thereof, and related methods. RF-photonic receivers and transmitters have advantages in processing information of received RF signals and/or RF signals to be transmitted in the optical realm.

### RELATED APPLICATION

This application is a non-provisional of U.S. Application No. 63/408,426 filed Sep. 20, 2022, the entire contents of which are hereby incorporated by reference.

### BACKGROUND

This application relates to RF-Photonic antennas and antenna arrays, components thereof, and related methods. RF-photonic receivers and transmitters have advantages in processing information of received RF signals and/or RF signals to be transmitted in the optical realm.

### SUMMARY

Some embodiments of the invention may help establish multiple, broadband, simultaneous, wireless, radio-frequency (RF) communication links. Embodiments may use optical up-conversion (for receiving, or RX) and/or down-conversion (for transmitting, or TX) of RF signals to/from optical domain so as to allow optical transport and optical processing of RF signals.

### BRIEF DESCRIPTION OF THE DRAWINGS

FIGS. 1a and 1b illustrate examples of faceted phased arrays; of each of these applications hereby being incorporated by reference in its entirety.

FIGS. 2a, 2b and 2c illustrate an example of a dielectric dome with a faceted cavity in the bottom for RF beam forming;

FIGS. 3a and 3b illustrates a Luneburg lens in combination with electro-optic transceiver array for RF beam forming. FIG. 3c illustrates a plurality of modules (which may be up-conversion modules, down-conversion modules or a combination of both) formed on the back surface of the Luneburg lens;

FIG. 4 illustrates an example of Luneburg lens modified with faceted bottom obtained from a regular polyhedron;

FIG. 5 is a functional schematic of a photonic integrated circuit;

FIGS. 6a and 6b illustrate details of an exemplary up-conversion module, FIG. 6a being an exploded view of FIG. 6b;

FIGS. 7 and 8 illustrate an array of resonant antennas coupled to Broadband, Efficient, Small-footprint, Thin-film (BEST) modulators;

FIG. 9 illustrates exemplary antennas providing tuning in response to an RF wave;

FIGS. 10 to 15 illustrate exemplary modulator configurations;

FIGS. 16, 17 and 19 illustrate exemplary photonic heterodyne links with homodyne detection (PHH links); and

FIG. 18 illustrates spectra of optical signals.

### DETAILED DESCRIPTION

Faceted Phased Array

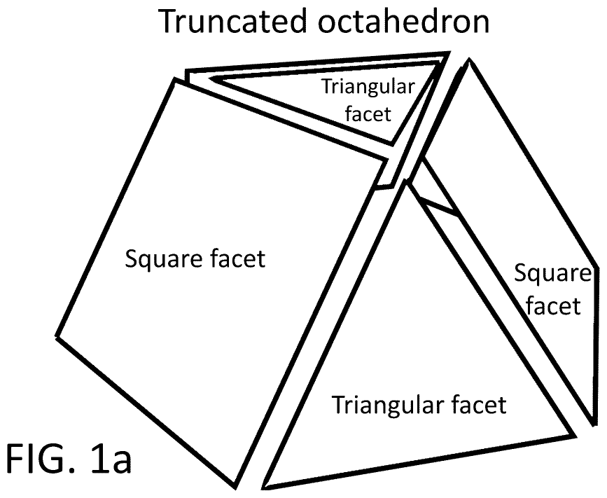

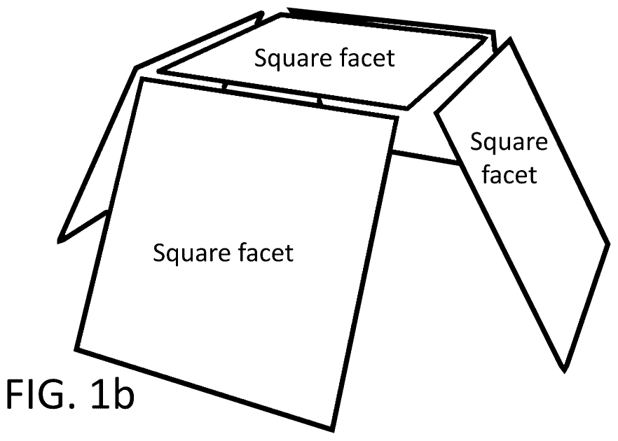

Phased array antennas may be used to form simultaneous multiple RF beams for RX and/or TX. Such phased arrays are typically planar, that is, the antennas of the phased arrays are distributed on a flat surface. As such, a planar phased array may be unsuitable for forming radio beams over a wide range of solid angles due to degraded beam-forming ability for directions near the array plane. To alleviate this degradation, multiple flat phased arrays may be used, each covering a smaller range of solid angles. FIG. 1a shows an example of such a faceted phased array that includes four triangles and three squares obtained from a truncated octahedron by removing its bottom half. In the illustration, the facets are slightly shifted and resized to show features that may be normally hidden. In this configuration, each facet has its own phased array covering a portion of the solid angle around its broadside so that in combination, the seven arrays cover a steradians. The facets may be populated with regular arrays (e.g., a 2D array of regularly or irregularly arranged antennas). In some implementations, for best coverage of the area, the triangular facets may be populated with antennas on a triangular lattice whereas the square facets may utilize either square or triangular lattice. However, other configurations of antenna arrays may be considered for the flat facets, including irregular arrays.

For consistency, and to facilitate fabrication, the facets may all be, for example, rectangular. FIG. 1b shows an example of an array where all facets are square. This configuration resembles a cube with the bottom facet removed and the side facets tilted off vertical. The tilt angle of the side facets is chosen so that the solid angle coverage may fill the 2π steradians. For example, with a 30-degree tilt off vertical, the elevation-direction coverage of +/−60 degrees, and azimuth coverage of +/−75 degrees of the side facets, in combination with +/−60 degrees coverage of the top facet, may provide a full 2π steradians coverage of the antenna array. Furthermore, the facets may be not exactly planar, but the surface may deviate from planar geometry. For example, the individual facets may be segments of a sphere, or of an ellipsoid, or of a hyperboloid, or of a paraboloid, or of a cylinder, or of any other two-dimensional surface. In some examples, the directions of the received or transmitted waves may cover a solid angle between nearly 2π and full 4π steradians.

Notably, advantages of using the faceted phased arrays include the formation of a cavity behind the facets. This cavity may be used to house electronic and/or optical components serving to support the operation of the system.

The faceted phased arrays comprising multiple planar RF-optical phased arrays may utilize one or more free-space optical processors to form multiple simultaneous beams, as described, e.g., in U.S. Pat. No. 9,525,489, or in U.S. Pat. No. 11,152,700, or in U.S. patent application Ser. No. 17/457,528, or in U.S. patent application Ser. No. 17/457,519, or in publication WO 2020/163881 A2, each of these patent documents being incorporated by reference in its entirety. Alternatively, the phased arrays may utilize photonic integrated circuits (PIC-s) for RF beam forming in the optical domain. In the latter case, AB mapping disclosed in U.S. patent application Ser. No. 17/160,676 (herein incorporated by reference in its entirety) may be utilized to form RF beams in 2D, e.g., azimuth and elevation, using only a planar PIC and a linear array of optical waveguides.

The faceted phased arrays comprising multiple planar RF-photonic phased arrays may also be used in combination with a tunable optical paired source (TOPS) described in publication “Radiofrequency signal-generation system with over seven octaves of continuous tuning” by G. J. Schneider, J. A. Murakowski, C. A. Schuetz, S. Shi, D. W. Prather, that appeared in Nature Photonics, Volume 7, Issue 2, pp. 118-122 (2013) (herein incorporated by reference in its entirety), or in U.S. Pat. No. 8,848,752, or in U.S. Pat. No. 11,424,594, each of these patents being incorporated by reference in its entirety. Combining the faceted phased arrays with TOPS may allow the down-conversion of the incoming radio-frequency signal to intermediate frequency (IF) or to baseband to facilitate subsequent processing. When implemented in a TX system, the combination of the faceted phased arrays with TOPS may allow the up-conversion of IF signals to RF for transmission.

Beam Forming in RF Domain

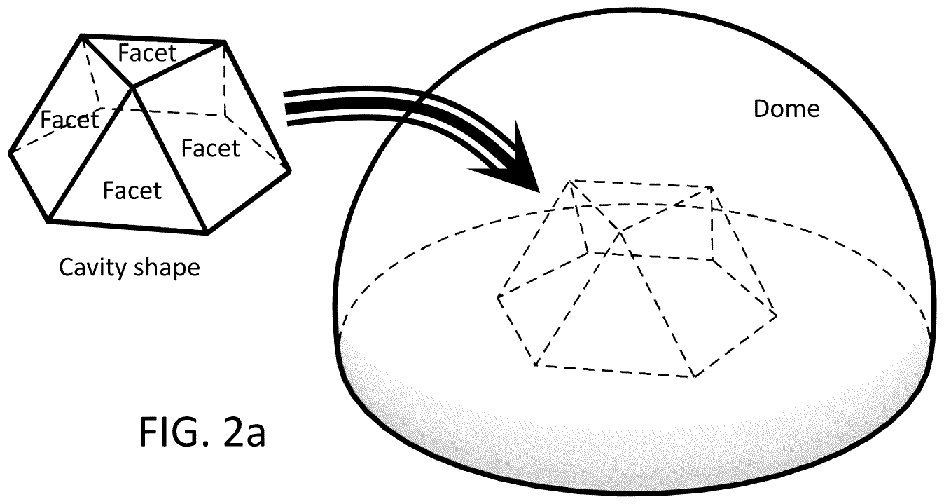

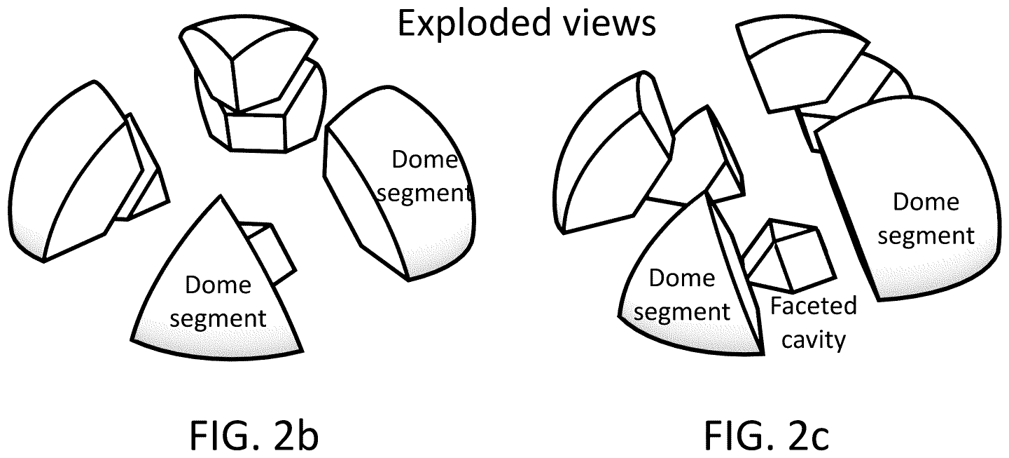

An alternative to using RF-photonic phased array and RF beam forming in optical domain is direct beam forming in the RF domain. To this end, one of several different approaches may be utilized. In one embodiment, a faceted cavity may be formed in the bottom of a dielectric dome as illustrated in FIG. 2a. The dome may be segmented, as illustrated in FIGS. 2b and 2c, where each segment is responsible for beam forming at the corresponding facet. Thus, the dielectric material of each segment is structured to behave like a dielectric lens and focus incoming RF plane waves to points at the corresponding facet. The facets may be populated with RF antennas to receive the focused RF radiation in the RX mode of operation, or to transmit RF waves for TX. In the latter case, the approximately spherical wave emanating from an antenna located at the facet may become an approximately plane wave as it exits the dome. The dielectric-lens behavior of each dome segment may be achieved by filling the solid angle occupied by the dome with a convex dielectric RF lens. Alternatively, the dielectric constant of the material may be varied so as to produce a GRIN (gradient-index) lens filling the solid angle of the dome segment. In another embodiment, a diffractive lens may fill the solid angle of the dome segment to form an image of the RF scene on the respective facet.

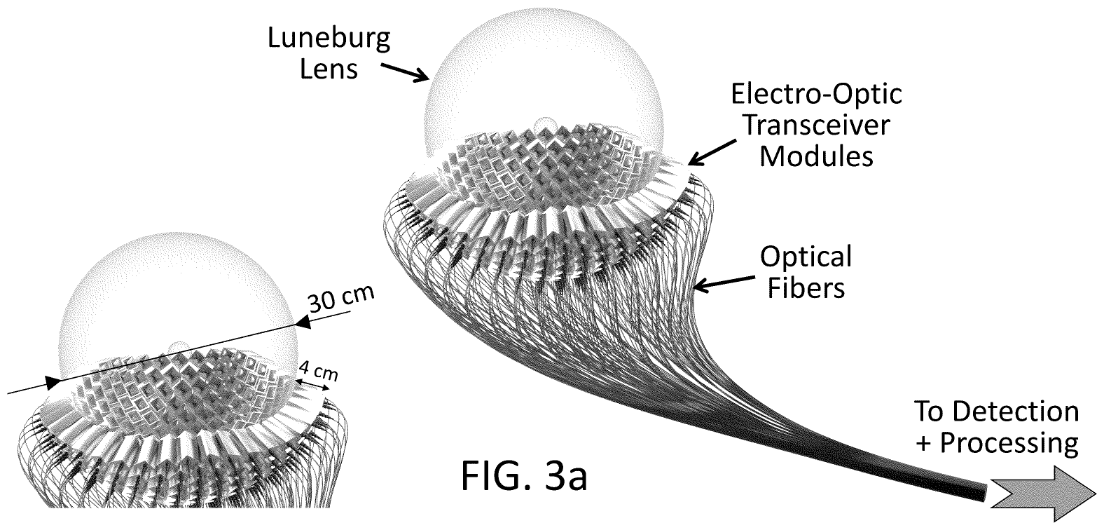

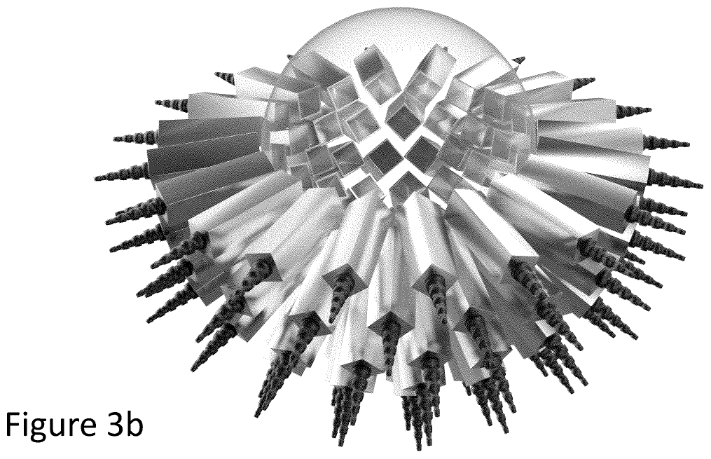

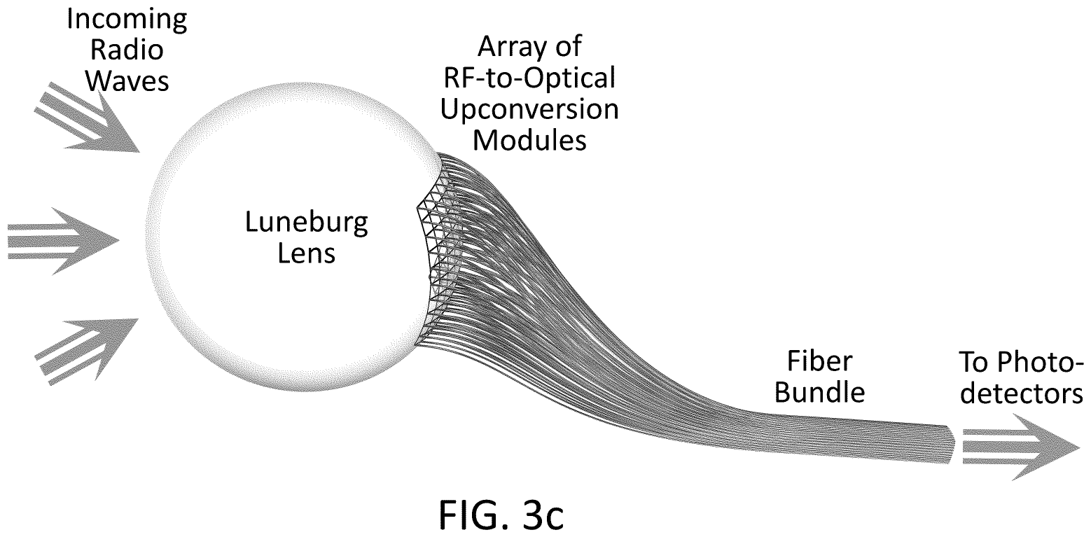

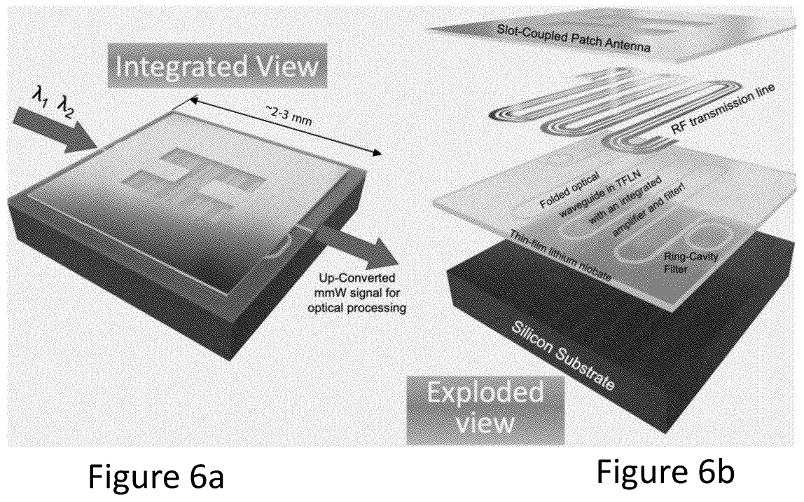

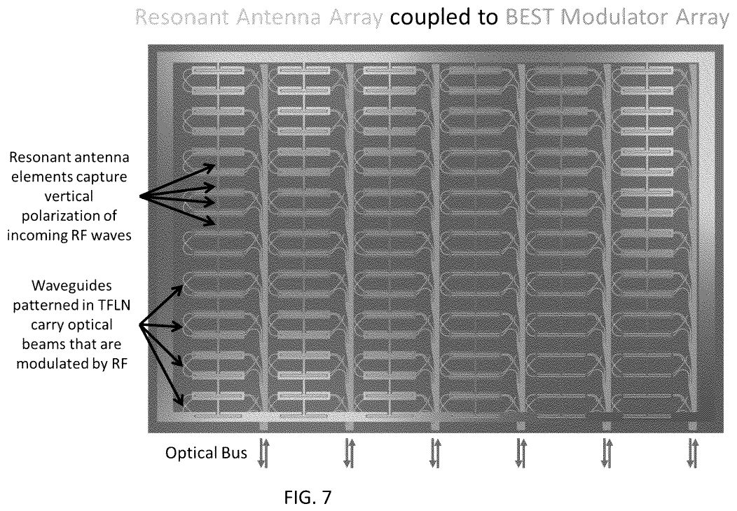

A Luneburg lens (LL) or other focusing lens may be utilized to form RF beams. FIGS. 3a and 3b illustrates one embodiment where the LL is used in combination with an array of electro-optic transceiver modules (EOTM s). FIG. 7 illustrates a plurality of such modules formed on the back surface of the Luneburg lens (each represented as a square on the Luneburg lens). It will be appreciated that while a transceiver is described in detail, the portions of this description relevant to a receiver/receiving will be understood to be applicable to a receiver only embodiments (without combining with a transmitter) and, similarly, the portions of this description relevant to a transmitter will be understood to be applicable to a transmitter only embodiments (without combining with a transmitter). In the receiver only embodiments, the transceiver modules may be replaced by up-conversion modules (converting an RF signal to an optical signal), and in the transmitter only embodiments, the transceiver modules may be replaced by down-conversion modules (converting an optical signal to an RF signal). The EOTM-s may be formed as the combination of an up-conversion module and down-conversion module. The EOTM of the transceiver/receiver/transmitter may comprise the photonic integrated circuit as described in U.S. provisional patent application 63/345,087 filed May 24, 2022 and U.S. patent application Ser. No. 18/201,723 filed May 24, 2023 (both of these application being herein incorporated by reference in its entirety) or a modified version thereof to implement one or more of the embodiments described herein. The array follows the curvature of the LL along its bottom portion. In the RX mode of operation, the EOTM may comprise an RF antenna to capture the incoming radiation followed, optionally, by a low-noise amplifier (LNA) and an electro-optic (EO) modulator. The components of EOTM may be co-packaged in a single housing so as to minimize signal coupling losses. For example, the EOTM may be formed as shown in FIGS. 6a and 6b, and described in further detail in U.S. provisional patent applications 63/345,087 and Ser. No. 18/201,723. The modulator up-converts the RF signal to the optical domain by modulating an optical carrier, e.g., the output of a laser, with the RF signal output by the LNA. The optical output of the modulator may be carried by an optical fiber, as provided for in FIGS. 3a, 3b and 3c. To simplify the system, the EOTM s may utilize folded EO modulators where the optical input and optical output are on one end of the modulator chip whereas the RF input is on the opposite end; compare FIG. 13 showing BEST modulator with a similar arrangement of optical and RF ports. As a result, the RF end of the modulator may face the LL, wherefrom the RF signals arrive, and the optical fibers connect at the opposite end of the EOTM.

In the TX mode of operation, the EOTM may comprise a photo-detector, an amplifier (optionally), and an antenna. In this case, the modulated optical signal arrives at the photo-detector, which converts it to electrical signal that, after amplification, feeds an RF antenna. The approximately spherical RF wave originating at the antenna is launched into the LL, which converts it to an approximately plane wave for propagation in free space.

The TX and RX functionality may be combined in a single EOTM with the antenna shared between TX and RX or with separate antennas serving the two functions. To this end, the transmitted signal may be isolated from the received signal by time-division multiplexing, frequency-division multiplexing, an RF circulator, or a combination thereof.

Notably, an LL focuses incoming plane waves on the surface of the sphere opposite the incoming wave. To accommodate the EOTM-s, a ‘socket’ array may be fabricated, e.g., 3D printed, that conforms to the spherical surface and accepts the EOTM-s to hold them against the LL. Additionally, in some applications, it may be advantageous to focus the incoming radiation on a planar, rather than curved, surface so that the array of EOTM-s follows a planar geometry. Such functionality may be achieved by utilizing the methods of transformational optics to convert the curved focal surface to a focal plane. Furthermore, wide field of view may be achieved by combining several such planar surfaces into a faceted bottom of a modified LL, as in an exemplary illustration of FIG. 4. The desired faceting may be generated using regular polyhedron as shown in the figure where a part of a truncated octahedron is used. Alternatively, for ease of fabrication, square facets may be used in a configuration similar to that of FIG. 1B. (Note: US 2022/0239007 A1 and WO 2021/236822 A1 describe faceted-bottom modified LL for RF beam forming; however, they don't appear to use regular polyhedra or square (rectangular) facets to define the planar surfaces. Using such regular structures may be advantageous in system fabrication and/or its performance.)

TOPS may be used in combination with RF beam-forming approach to convert from RF to IF (or baseband) in the RX configuration, or to convert from IF (or baseband) to RF in the TX configuration. In the RX case, the TOPS may be tuned to produce frequency difference between the laser outputs equal to RF−IF or RF+IF. Then, one of the TOPS outputs may be modulated by the incoming RF signal whereas the other may be used as a reference. At a photo-detector, one of the modulation sidebands may be mixed with the reference to yield IF modulated with the information-bearing signal carried by the RF captured by the antenna. In the TX case, the TOPS may be tuned to produce frequency difference between the laser outputs equal to RF−IF or RF+IF. Then, one of the TOPS outputs may be modulated by the information-bearing signal to be transmitted; the signal may be presented to the modulator either at baseband or at IF. The other TOPS output serves as a local oscillator (LO). One of the modulation sideband may be then mixed with the LO at the photodiode in the EOTM to produce RF signal modulated with the information to be transmitted from the antenna.

Optical communication between the elements of the LL-based radio head and the processing unit may be also established using photonic heterodyne link with homodyne detection (PHH link) described elsewhere herein. The PHH link inherently down-converts the incoming RF signal to IF while relying on a particularly simple EO phase modulator in the radio head and TOPS to generate the frequency-offset laser outputs. The use of a down-converting link may simplify the down-stream electronics for signal processing and increase the effective number of bits available at the output as compared to direct digitization of the signal at the incoming RF.

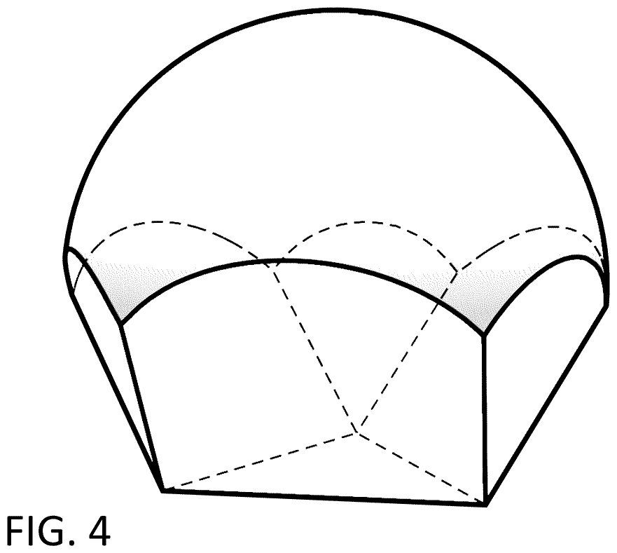

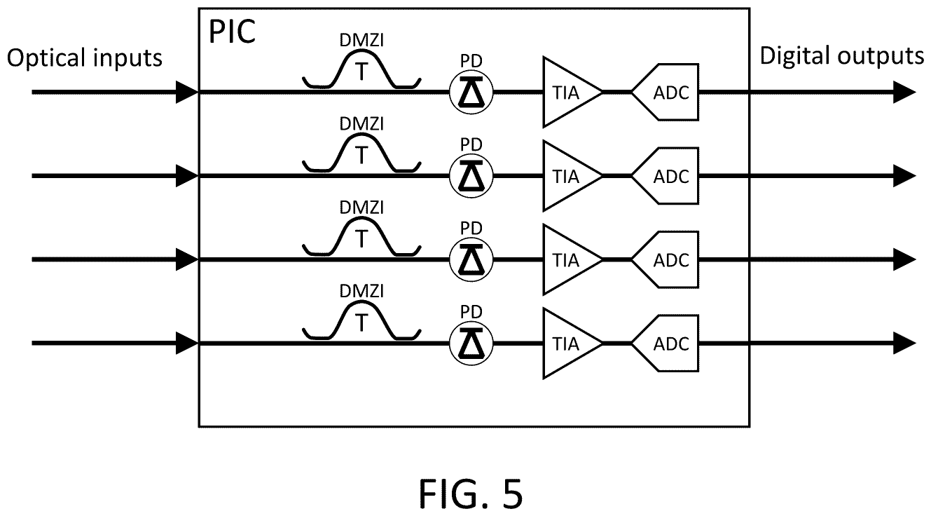

The PHH link relies on a differential (unbalanced) Mach-Zehnder interferometer (DMZI) for signal down-conversion to IF and its detection. Multiple such DMZI-s may be integrated on a single photonic integrated circuit (PIC) that may rely on thin-film lithium niobate (TFLN) or silicon (silicon on insulator, SOI) substrate for optical processing. If using SOI, the PIC may also include additional processing components such as photo-detectors (PD-s), trans-impedance amplifiers (TIA-s), and analog-to-digital converters (ADC-s). FIG. 5 is a functional diagram of an SOI-based PIC that includes these functionalities. Alternatively, some of the components may be off-PIC to take advantage of the best-performing, or lower-cost commercial off-the-shelf (COTS) parts. For example, the ADC-s may be separated from the PIC, or the TIA-s and ADC-s may be separate, or PD-s and TIA-s and ADC-s may be designed as a separate circuitry; in the latter case, the outputs of the PIC are optical rather than electrical and as such may allow the implementation of the PIC in materials other than SOI, including lithium niobate or silicon nitride.

If detecting broadband signals, the processing may benefit from optical channelizing prior to conversion from optical to electrical domain. A method that may be used for this purpose has been described in U.S. patent provisional application No. 63/272,457 (incorporated by reference in its entirety). In this case, for arrayed-waveguide-grating (AWG) PIC-s implemented in SOI, additional functionality may be included on the PIC, such as PD-s, TIA-s, and/or ADC-s.

To enhance modulation efficiency and to minimize the footprint of the devices, a broadband, efficient, small-footprint, thin-film (BEST) modulator may be used (described elsewhere herein). For narrow-band applications, the modulation efficiency may be further enhanced by using enhanced variant, narrow-band, twin-resonance (EVNBTR) modulator described in a separate document.

For efficient signal transport between the LL-based radio head and the processing unit, a multi-core optical fiber may be used in place of the fiber bundle illustrated in FIGS. 3a and 3b. In the RX case, the optical outputs of multiple EOTM-s may be combined in a single multi-core fiber, where each core is responsible for carrying the optical beam originating at one EOTM. The optical signals from the different cores of the multi-core fiber are separated for processing at the other end of the link. In the TX case, the modulated optical beams destined for the LL-based radio head are combined in a multi-core fiber where each core is responsible for conveying signal to a particular EOTM. At the radio head, the signals are separated and routed to the respective EOTM-s.

The use of a single optical fiber for signal transport between the radio head and the processing unit may also be accomplished by wavelength-division multiplexing (WDM). In the RX case, multiple optical carriers having different wavelengths are delivered to the radio head using a single fiber. At the radio head, the wavelengths are separated using AWG and routed to the EOTM where each EOTM may receive an optical carrier with its own dedicated wavelength. Upon modulation, the now modulated optical beams may be combined using another AWG for transport back to the processing unit on a single optical fiber. The same or separate fibers may be used for the delivery of the optical carriers and for the return of the modulated optical beams. When using a single fiber for optical communication in both directions, optical circulators may be used to separate the incoming and outgoing optical beams at the radio head and at the processing unit.

AWG and/or optical filters may also be used for optical power delivery to the radio head. In this case, no electrical (metal) connection may be necessary between the processing unit and the radio head. To this end, high power optical beam may be launched along with the optical carrier(s) to an optical fiber, or optical fibers, connecting the processing unit with the radio head. The high-power beam may be spectrally separated from the optical carrier(s), and the beams may be combined at the processing unit using add/drop filter(s) or AWG(-s). At the radio head, the high-power optical beam may be separated from the optical carrier(s) using add/drop filter(s) or AWG(s) and may illuminate a photo-diode, or multiple photo-diodes, operating in a photo-voltaic mode, whereby the photo-diode(s) generate electricity as a result of the interaction between the absorbed photons and electrons present in the material. Thus generated electricity may be used to power the electronic components of the EOTM-s in the radio head including LNA-s, PD-s, and power amplifiers.

The RF-receiver architecture according to some embodiments may be devoid of front-end low-noise amplifiers (LNA-s). Direct up-conversion of RF signals captured by an array of antennas to optical domain may be implemented using a corresponding array of electro-optic (EO) modulators. The modulation efficiency of the latter may be enhanced by exploiting both optical and RF resonances. Notably, the optical resonance need not lead to narrowing of the bandwidth, which is only limited by the design of the RF resonant antennas.

Optical modulators are an integral part of active and passive millimeter wave imaging systems, modern telecommunications networks and data communication, and are widely used in on-chip RF photonic devices, frequency comb generation, on chip signal splitting, sensing, and quantum photonics. The ideal optical modulator would use a PIC-compatible material system, maintain a small device footprint, and boast an ultra-wide frequency response. Silicon (Si) free carrier plasma dispersion-based modulation has been investigated due to its low-cost complementary metal-oxide semiconductor (CMOS)-compatible fabrication process and excellent scalability, but is inherently limited in extinction ratio and bandwidth. Si-based modulation is further limited by its low second-order non-linearity, intrinsic absorption loss, third-order non-linearity, narrow transmission spectrum, and undesirable dopant diffusion at high temperatures. Some of these issues can be mitigated through the integration of organic electro-optic materials with the Si platform, but the organic compounds do not lend themselves to long-term environmental stability. The ideal platform for a low-voltage, high-bandwidth and environmentally-stable modulator should show a strong electro-optic (Pockets) effect, and a linear response to an applied modulation voltage. As such, the Si-based free-carrier-plasma dispersion-based modulation platform is ruled out in favor of lithium-niobate-based modulation. Lithium niobate (LiNbO₃) offers an extremely strong second-order non-linearity (χ⁽²⁾) and as such a strong linear electro-optic effect, exceptionally low optical absorption across a wide spectrum, pure phase modulation, zero chirping, and stability at high temperatures. Moreover, LiNbO₃ boasts a third-order non-linearity (χ⁽³⁾) which is three orders of magnitude lower than Si.

Legacy, or bulk LiNbO₃ modulators that use titanium (Ti)-diffused waveguides to guide an optical mode, suffer poor optical confinement (Δn<0.02) resulting in a large mode size requiring metal electrodes to be placed far from the waveguide to avoid metal-absorption losses. Consequentially, the half-wave voltage (V_{π}) and the minimum optical bending radius of the device are greatly increased. Bulk LiNbO₃ modulators then have large footprints and high power requirements. A typical bulk LiNbO₃ modulator has a V_{π}·L of 12-32 V·cm. However, these limitations can be overcome using modulators made with crystal-ion-sliced (CIS) films of LiNbO₃ on insulator (TFLNOI), which guide optical modes almost 20 times smaller than their bulk-LiNbO₃ counterparts. As a result, the electrodes can be placed closer to the optical waveguide, leading to enhanced modulation efficiency, lower noise and power consumption, and PIC-compatibility. These devices can support bending radii near 250 μm, compared to roughly 1 cm in bulk LiNbO₃ devices. Ultra-wide bandwidth, high-efficiency, low-loss modulators have been demonstrated in the TFLNOI material system through ridge-etched or strip-loaded waveguides. To ensure compatibility with current CMOS silicon-based processes, silicon nitride (SiNₓ) may be chosen as the ideal candidate for hybrid integration. SiNₓ has a refractive index similar to LiNbO₃, and has low propagation loss across a wide optical spectrum. SiNₓ also features a low second-order non-linearity, small thermo-optic coefficient, high power-handling ability, is PIC compatible and can be easily grown or deposited using either plasma enhanced chemical vapor deposition (PECVD) or low pressure chemical vapor deposition (LPCVD). Finally, the use of 100-nm-thick SiN strip-loaded waveguides rather than ridge-etched TFLN waveguides, or 220-nm-thick SiN strip-loaded waveguides opens the door to the possibility of an efficient waveguide coupler at the end facet. As a result, a sub-1-volt V_{π} modulator in the hybrid thin film LiNbO₃—SiNₓ material platform has been demonstrated.

The benefits of TFLNOI listed above allow contemplating RF-photonic architectures with hitherto unattainable capabilities. One such architecture is considered here. It relies on broadband, efficient, small-footprint, thin-film (BEST) modulators with further enhancement of modulation efficiency through RF resonance. The resulting antenna-modulator array architecture may lead to modulation efficiency high enough to dispense with front-end low-noise amplifiers (LNA-s) that are normally required to boost the incoming RF signals to levels appropriate for optical up-conversion. Removing front-end LNA-s would usher a paradigm shift in wireless communication and sensing.

Below provides an overview of exemplary antenna-modulator array architecture as well s approaches to enhance modulation efficiency by exploiting optical and RF resonances; in some examples, optical resonant modulation enhancement need not lead to reduced bandwidth.

### Integrated Antenna-Modulator Array

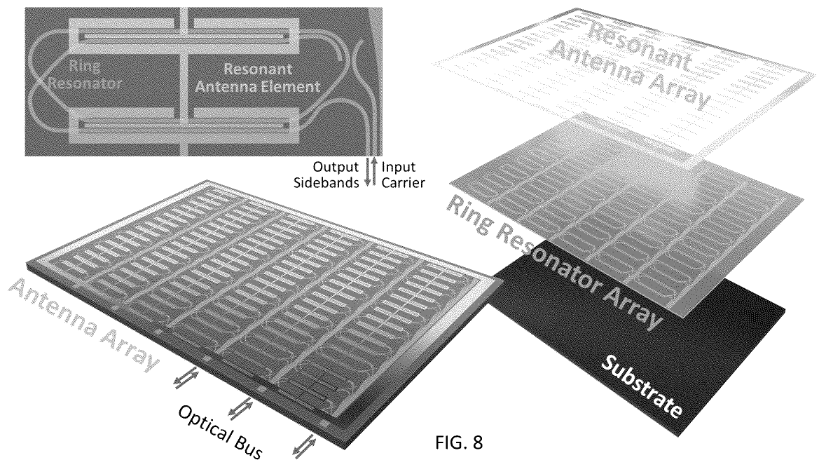

FIG. 7 shows a top-down view of an array of resonant antennas coupled to Broadband, Efficient, Small-footprint, Thin-film (BEST) modulators. FIG. 7 is a broadside view of the resonant antenna array coupled to TFLNOI modulators. The modulators rely on recycled-carrier-modulator (RCM) concept to enhance modulation efficiency while maintaining broadband operation. Bandwidth is narrowed and engineered by the RF resonance in the antenna elements. Antenna elements take the form of tightly coupled dipoles that are terminated with waveguides. In turn, the waveguides terminate without a load to allow for back reflection and building the resonance. In the coupling region, the antenna elements alternate between taking the role of signal and ground electrodes, see FIG. 8.

FIG. 8 shows further detail of the array concept. The upper-left is the close-up of one of the antenna elements and its position relative to the ring resonator patterned in TFLN. The latter includes a Mach-Zehnder Interferometer (MZI) that allows the separation of the carrier, which circulates in the ring, from modulation sidebands, which are extracted from the resonator. Such an arrangement yields carrier enhancement in the modulation region while preserving broadband operation of the modulator. Depending on the relative velocities of the RF signal and the optical signal in their respective waveguides, the optical waveguides might cross, as in FIG. 8, or not, in which case they would simply run parallel to one another around the bend. The bandwidth of the modulator is determined by the resonance of the antenna. Additional perspective, lower left, and exploded, right, views in FIG. 8 provide further detail on the relative placement of the different components.

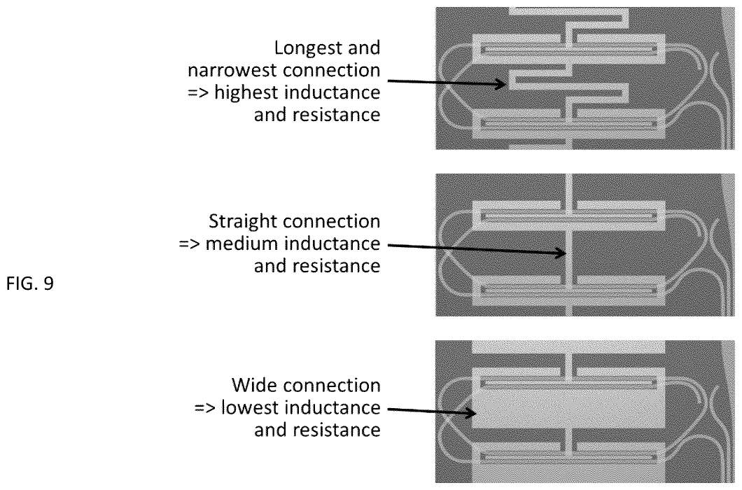

Notably, the antenna shape may be varied, as in FIG. 9, to tune the position of its resonance and/or response bandwidth. The top panel in FIG. 9 shows a narrow, meandering central electrode joining the top and bottom waveguide segments. Such a conductor trace yields increased inductance and resistance with associated lowering of the resonant frequency and Q. On the other hand, the bottom panel shows a wide metal trace joining the waveguide segments, which would naturally lead to lowering the inductance and resistance, with the attendant increase of resonant frequency and Q. The middle panel of FIG. 9 occupies the middle ground in inductance and resistance between the top and bottom panels. Additional geometry adjustments are possible that lead to the flexibility in the resonant response of the antenna elements that may be adjusted to fit a particular application.

Resonant Enhancement of Modulation

Small size of the optical mode in thin-film lithium-niobate on insulator (TFLNOI) allows for sharp waveguide bends. As a result, high-Q ring resonators may be realized in this material that provide for improved modulation efficiency. In conventional resonant modulators, the instantaneous bandwidth of the modulator response is limited by the resonance linewidth, which, in turn, is determined by the resonator Q. However, by separating the modulation sidebands from the optical carrier so that only the carrier resonates in the cavity, one may enhance modulation efficiency by resonantly increasing the power of the carrier while maintaining broadband response. Such a TFLNOI modulator offers the following advantages over traditional approaches:
High efficiency. Resonant enhancement by cavity-finesse factor.
Broadband operation. Same as that of a traveling-wave modulator.
Compact. Footprint may be as small a few hundred microns.
Carrier suppression. Nominally, only sidebands appear at the output.
In/Out configuration. Optical in/out on the same side, RF input opposite.
Relaxed index matching. Short interaction region allows RF/optical index mismatch.
Feasibility. Uses elements already demonstrated in fabrication.

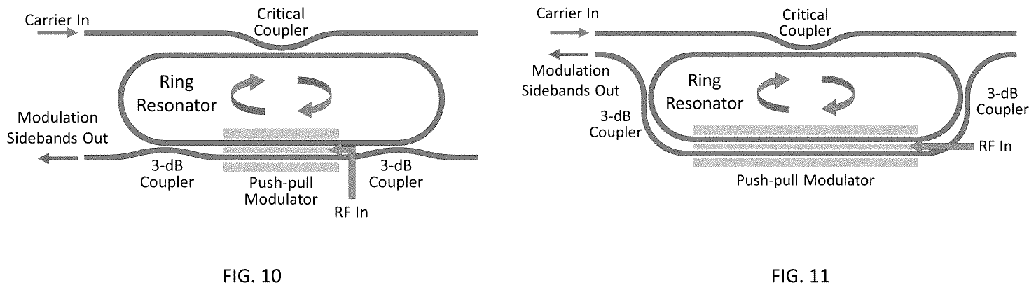

FIG. 10 shows a conceptual diagram of the modulator architecture. It takes advantage of resonant optical-carrier enhancement in a ring cavity to boost efficiency. Extraction of modulation sidebands in a null-biased MZM has a two-fold effect: (1) optical carrier is suppressed at the output, and (2) broadband response is retained since the sidebands do not circulate in the cavity.

The modulator works as follows. Optical carrier enters through the upper-left port labeled “Carrier In” in FIG. 10 and couples to a ring resonator via a directional coupler. The resonator is tuned to the wavelength of the carrier, and the coupling is critical so as to maximize the optical power circulating in the resonator. With such critical coupling, the optical power in the waveguide of the ring equals cavity-finesse times the input power. The bottom portion of the cavity forms a Mach-Zehnder interferometer (MZI) with a second waveguide. Ground-signal-ground (GSG) electrodes of an RF waveguide along the optical waveguides of the MZI turn the latter into an MZM. The MZM is null biased so that in the absence of a modulating signal, indicated as “RF In” in FIG. 10, all optical-carrier power stays in the resonator and none exits through the lower-left port.

Applying push-pull modulation to the arms of the MZM generates optical sidebands. Thanks to null-biasing, the sidebands exit the MZM through a different port than the optical carrier. As a result, whereas the carrier stays in the ring, the sidebands exit the resonator, and the modulator, through the port labeled “Modulation Sidebands Out” in FIG. 10.

The basic configuration of FIG. 10 may be modified to further improve modulation efficiency by increasing the interaction length between the RF and optical signals without increasing the overall size of the device. FIG. 11 shows such a modification. Therein, the 3-dB couplers, that are part of the MZM, are formed along the curved portions of the resonator. As a result, the entire straight bottom segment of the resonator may be used for the push-pull MZM.

Note also that the electrodes forming the RF waveguide need not turn in either configuration of FIG. 10 or 11: They can proceed straight from the input on the right edge of the device to the interaction region. Such an arrangement of the RF waveguide simplifies its design and operation at high frequencies, and provides for better impedance matching that results in improved modulation efficiency as compared to a modulator where a GSG waveguide turns.

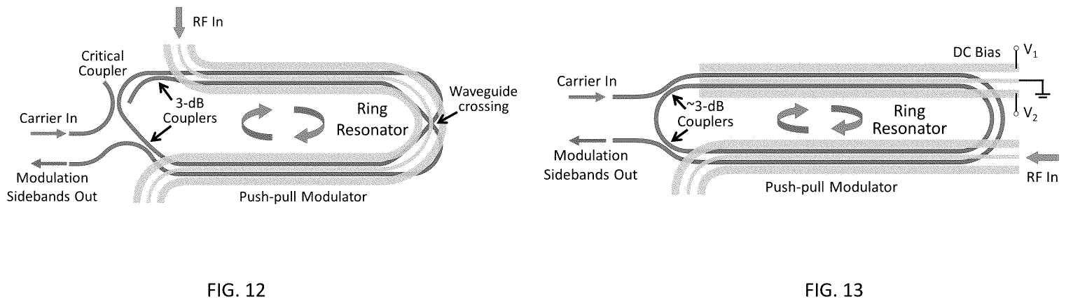

However, if the priority is on maximizing the interaction length, the modulator may be reconfigured as in FIG. 12. In this case, the RF waveguide follows the curvature of the ring-resonator optical waveguide. A slight complication arises when the modulator is patterned in X-cut lithium niobate since making a U-turn would change the polarity of the modulation, which would reduce modulation efficiency. To maintain modulation polarity, the optical waveguides may cross at the U-turn, as indicated in FIG. 12. Such waveguide crossing has been implemented in fabricated devices. Otherwise, the operation of the modulator of FIG. 12 is similar to the operation of the modulators shown in FIG. 10 or 11.

The configuration of the BEST modulator may be further modified, as shown in FIG. 13, to eliminate one of the couplers. In this case, the role of the critical coupler is taken over by the 3-dB couplers that are already part of the Mach-Zehnder modulator within the resonant cavity. In operation, the ˜3-dB coupling may be first adjusted with just the incoming optical carrier coupled to the Carrier-In port to minimize the amount of light exiting through the Modulation-Sidebands-Out port. This adjustment may be performed in combination with the DC-Bias adjustment to ensure that the resonance of the cavity coincides with the wavelength of the optical carrier. Minimizing the output carrier power may ensure that the pair of the ˜3-dB couplers serves the role of a critical coupler and may maximize the optical power circulating in the resonant cavity.

After adjusting the ˜3-dB couplers and the DC Bias for minimum carrier output, the operation of the BEST modulator in the configuration of FIG. 13 is similar to those described above in combination with FIGS. 10 through 12, showing a BEST modulator with a reduced number of coupling regions and separate bias electrodes.

An alternative way to operate BEST modulators is to use erbium-doped lithium niobate and inject pump laser power into the resonator rather than the optical carrier directly. The pump would excite lasing in the cavity, and the MZM would generate modulation sidebands on the lasing mode. Such an arrangement may render the optical power of the carrier circulating in the cavity more stable in this case.

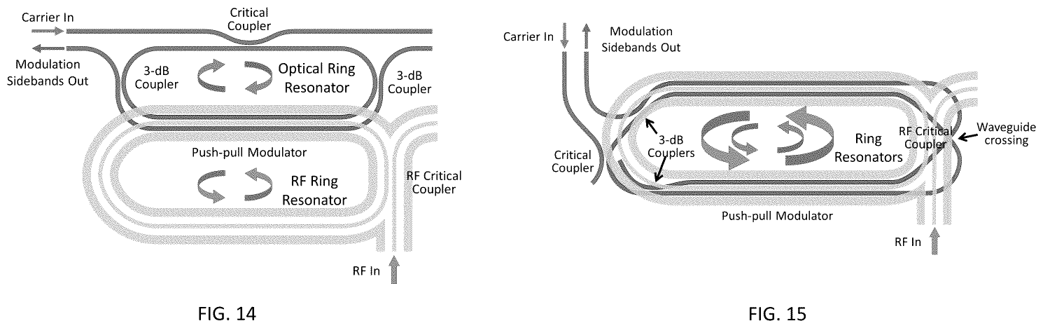

The BEST modulator discussed above may be modified to resonantly enhance the RF signal in addition to and independently of the optical-carrier enhancement. In the process, the bandwidth of the modulator is narrowed by the RF-cavity Q. FIG. 14 shows an example configuration that may be used for this purpose.

FIG. 14 illustrates an example of an Enhanced Variant, Narrow-Band, Twin-Resonance (EVNBTR) modulator utilizing twin resonances to enhance modulation efficiency in a small footprint.

In FIG. 14, optical carrier enters through the upper-left port labeled “Carrier In.” It couples to the optical ring resonator through a critical coupler, which provides for maximizing the optical power circulating in the cavity. The bottom segment of the optical ring resonator forms a null-biased push-pull Mach-Zehnder modulator with a second waveguide and GSG electrodes of an RF waveguide. The RF waveguide is closed to form a ring resonator where the electronic signal circulates and, in the segment overlapping the optical waveguide, propagates in the same direction as the optical carrier. The RF signal enters through the bottom-right port labeled “RF In,” and couples to the ring through a directional, critical RF coupler. The size of the RF ring cavity is chosen so that the center of the desired band falls on the cavity resonance, and the cavity's Q provides for the resonator operation across the desired bandwidth. This way, both the optical carrier and the RF signal are resonantly enhanced for improved modulation efficiency.

The configuration of FIG. 14 may be further modified to increase the interaction length between the RF signal and the optical carrier. To this end, the two rings may be overlaid as in FIG. 15. The Mach-Zehnder modulator now covers the two long straight segments of the resonator between 3 dB couplers. It is null biased and includes waveguide crossing for an X-cut lithium niobate to ensure consistent polarity of the modulation. As in the previous cases, critical coupling is employed to launch the optical and the RF signals in their respective resonators to maximize their amplitudes and thereby their interaction.

FIG. 15 illustrates an example of an EVNBTR modulator with increased interaction region. The reduced footprint of FIG. 15 configuration compared to FIG. 14 appears to come at the cost of requiring a better match between the optical index and the RF index for the waves propagating in the respective waveguides. However, the index-matching constraint may be to some extent relaxed by properly engineering the vertical segments of the resonators where the waves do not interact.

When integrating BEST modulators directly with antennas, as in FIGS. 7 and 8, and exploiting RF resonance for modulation enhancement, the electrodes of the RF-portion of the modulator may be considerably simplified. FIG. 9 above illustrates this possibility by merging the functionality of the antenna and the modulation regions.

Elements of the technology required to realize the architectures presented above have been already demonstrated. Example of devices may be realized in TFLNOI with elements directly applicable to the photonic phased-array antenna.

Photonic Heterodyne Link with Homodyne Detection (PHH LINK)

A photonic heterodyne link with homodyne detection (PHH link) according to some embodiments may combine the benefits of optical heterodyning that allows the shift of radio frequency (RF) signals to intermediate frequency (IF) and homodyne detection that makes the system tolerant to environmental disturbances. It relies on phase modulation of an optical beam comprising two optical wavelengths separated in frequency by the difference between the RF and the IF. Homodyne detection employing and unbalanced Mach-Zehnder (MZ) interferometer yields the signal shifted to IF. When used in remoting an RF receiver, it provides for a particularly simple radio head that employs only a conventional phase modulator that is free from the need of biasing circuitry typically required in MZ modulators. The concept may be applied in other RF-over-fiber applications as means to shift parts of system complexity to the preferred end of the link.

Architecture

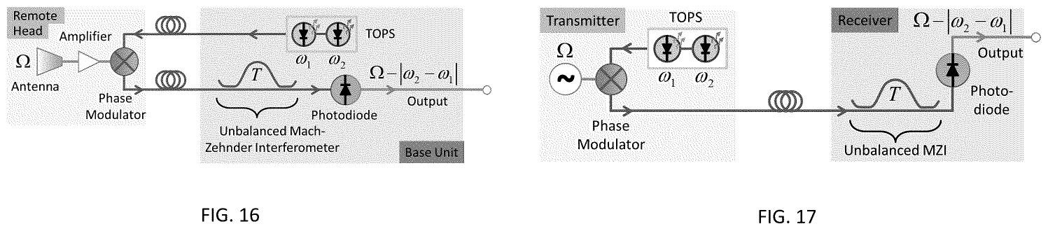

FIG. 16 shows a schematic diagram of an example of a PHH link. Blue lines indicate optical paths and orange lines indicate electrical paths. Box shaded light-yellow is the remote head unit whereas the light-blue box outlines the base unit. Radio-frequency (RF) signal at carrier frequency S) enters through an antenna, is amplified, and modulates the phase of an optical beam. The latter comprises outputs of two lasers phase locked to each other, as in e.g., TOPS (tunable optical paired source), and delivered to the modulator in an optical fiber. The optical frequencies of the laser-outputs oscillations are ω₁ and ω₂. The modulator output travels in an optical fiber to an unbalanced Mach-Zehnder interferometer with a time-delay difference T between its two arms. The output of the Mach-Zehnder interferometer impinges on a photo-detector, which produces electrical output at a frequency Ω−|ω₂−ω₁|.

According to the description above, one or more of the following advantages of this link architecture compared to conventional alternatives may be implemented.
Optical-fiber delivery. Low loss in optical fibers allows large separation between the remote and base units while maintaining signal integrity.
Conversion from RF to IF. Conversion of the incoming RF frequency S) to intermediate frequency (IF) Ω−|ω₂−ω₁| simplifies detection and subsequent processing of received signals.
Robustness 1. Because both optical tones, which serve as optical carriers of the RF, travel in the same fiber, and in the same mode of the fiber, they are subject to the same environmental conditions. As a result, their relative phase is insensitive to environmental perturbation such as vibration, temperature change, or acoustics.
Robustness 2. Because the RF signal is encoded in the phase of the optical beam, the transmission is less sensitive to optical amplitude variation than are IMDD (intensity modulation, direct detection) links. In a way, PHH is to IMDD as FM is to AM radio
Simplicity. The remote unit is particularly simple. It contains an antenna, a low-noise amplifier chain and a phase modulator. The latter requires no active bias adjustment, which simplifies design, operation, and servicing as compared to, e.g., a Mach-Zehnder modulator. The complexity is shifted to the base unit, which, generally, operates in a more stable environment and allows better access for service.
Flexibility. FIG. 17 illustrates an example of a PHH link with TOPS in the transmitter module. The architecture may also be used in the configuration of FIG. 17 where the laser source is in the same location as the RF input. In this case, a single optical fiber is used from the transmitter to the receiver module. (Note: Single-fiber connection may also be realized by using fiber circulators on both ends of the link.)
Synergy. The architecture leverages PSI's expertise developed under prior and current projects: TOPS has been under development for several years and appears to be mature as a commercial product; unbalanced Mach-Zehnder interferometer (MZI) has been employed for homodyne detection in a sponsored project before.

In FIGS. 16 and 17, the unbalanced MZI is placed in the base unit or receiver module. However, note that the MZI may be, generally, placed anywhere along the fiber connecting the modulator to the photo-diode. For example, the MZI may be placed in the transmitter. The location of the MZI is flexible and may be selected to benefit a particular application.

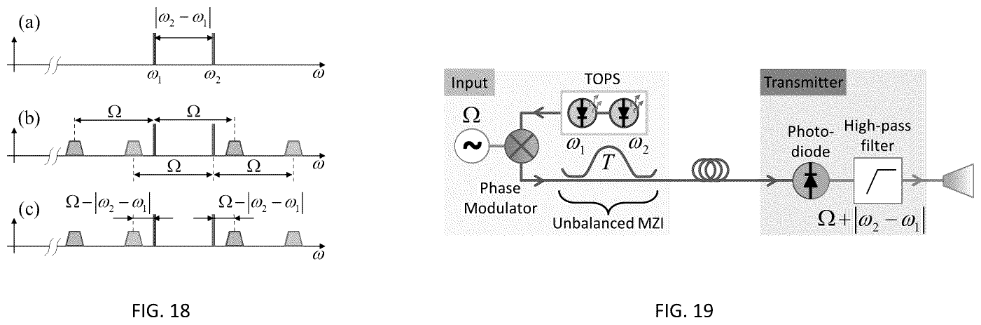

The operation of the system may be understood with the help of signal spectra at various points as shown in FIG. 18. FIG. 18 illustrates spectra of optical signals with (a) illustrating two optical CW tones generated by TOPS spaced |ω₂−ω₁| apart (b) illustrating modulated optical signals include sidebands separated from the corresponding carriers by modulation frequency Ω and (c) illustrating each sideband is separated from the other carrier by frequency Ω−|ω₂−ω₁|. TOPS generates two spectral lines that are phase-locked, and separated spectrally as shown in (a) of FIG. 18; the spectral lines are shown in (a) of FIG. 18 using different colors: red for optical frequency ω₁ and green for optical frequency ω₂. The two optical tones are modulated by the RF signal at a carrier frequency Ω, as illustrated in FIG. 16, to produce corresponding sidebands shown in (b) of FIG. 18. The sidebands corresponding to optical-carrier frequency ω₁ are shaded red whereas the sidebands corresponding to optical-carrier frequency ω₂ are shaded green. Note that the sidebands are separated from their respective optical-carrier frequencies by the frequency of the RF signal Ω. The spectral separation |ω₂−ω₁| between the optical carriers is chosen to be somewhat smaller than the RF carrier frequency Ω. As a result, the upper modulation sidebands corresponding to optical carrier ω₁ lies just above ω₂ whereas the lower modulation sideband corresponding to optical carrier ω₂ lies just below ω₁. The spectral separation between the sidebands and the other carriers are identical. As a result, when mixed on a photo-detector, the two pairs contribute to the same output frequency Ω−|ω₂−ω₁|. Thus, the amplitude of the photo-detector output depends on the relative phase between the two contributing signals. This relative phase is critical to the detection. For example, note that if a photo-detector were placed directly after the modulator, its output would contain no information about the modulating signal. Rather, only a beat tone at a frequency |ω₂−ω₁| would be generated regardless of the modulation. This is because the two contributions to the output frequency Ω−|ω₂−ω₁| are out of phase and as such cancel out.

Below, homodyne detection, where the composite modulated signal is mixed on a square-law photo-detector with its delayed copy, is discussed. Homodyne detection, where the modulated signal is mixed with its delayed version, provides for the conversion of the optical modulated signal to electrical domain. The starting point in the analysis is the optical amplitude at the output of the modulator:

E(t)=A₁ exp[iω₁t+im sin(Ωt)]+A₂[iω₂t+im sin(Ωt)], (1)

where A₁ and A₂ are the amplitudes of the optical carriers at frequencies ω₁ and ω₂, respectively, and will be assumed identical in the analysis below, A₁=A₂=A. For homodyne detection, the modulated optical beam represented by E(t) in (1) is split into two identical beams, one of the beams is delayed with respect to the other, and the two beams are combined again as in the unbalanced MZ interferometer of FIG. 16. Thus, the optical amplitude at the interferometer output is:

$$\\ \begin{matrix}{E}_{MZI} ( t ) = \frac{A}{2} \{ \begin{matrix}exp [ i {ω}_{1} t + im sin ( Ω t ) ] + \\ exp [ i {ω}_{2} t + im sin ( Ω t ) ]\end{matrix} \} + \frac{A}{2} \{ \begin{matrix}exp [ i {ω}_{1} ( t + T ) + im sin ( Ω ( t + T ) ) ] + \\ exp [ i {ω}_{2} ( t + T ) + im sin ( Ω ( t + T ) ) ]\end{matrix} \} . & ( 2 )\end{matrix}$$

The photo-diode effectively takes the absolute value squared of the optical amplitude E_{MZI}(t) and averages the result over a time period that is long compared to the optical oscillations. In addition, we assume here that the averaging time is long compared to the difference frequency |ω₂−ω₁| and to the frequency of the incoming signal Ω, but short compared to the intermediate frequency Ω−|ω₂−ω₁|. With these assumptions, after simple algebra, we can write the term linear in the modulation amplitude m at the photo-diode output as

$$\\ \begin{matrix}{V}_{PDm} = - m {\vert A \vert}^{2} sin ( \frac{{ω}_{1} + {ω}_{2}}{2} T ) sin [ \frac{Ω T}{2} ] cos [ ( Ω - \vert {ω}_{2} - {ω}_{1} \vert ) ( t + \frac{T}{2} ) ] . & ( 3 )\end{matrix}$$

In (3), m is proportional to the input RF signal amplitude, whereas |A|² is proportional to the input optical-carrier power. The next term,

$$\\ sin ( \frac{{ω}_{1} + {ω}_{2}}{2} T ) ,$$

indicates that the relative optical phase between the arms of the MZ interferometer should be adjusted such that

$$\\ \begin{matrix}\frac{{ω}_{1} + {ω}_{2}}{2} T = \frac{π}{2} + n π & ( 4 )\end{matrix}$$

to maximize linear system response; this adjustment corresponds to quadrature bias point of the unbalanced MZ interferometer at the mean optical-carrier frequency (ω₁+ω₂)/2. The term

$$\\ sin {}^{} ( \frac{Ω T}{2} )$$

in (3) sets the maximum response of the link at RF frequencies such that

$$\\ \begin{matrix}\frac{Ω T}{2} = \frac{π}{2} + π n {f}_{RF} T = \frac{1}{2} + n , where n ∈ \{ 0 , \pm 1 , \pm 2 , … \} , & ( 5 )\end{matrix}$$

and limits the bandwidth of the link response; for the first maximum response, n=0 in (5), the 3-dB bandwidth is between f_{RFmin}=(4T)⁻¹ and f_{RFmax}=3(4T)⁻¹. Thus, the FHH link covers 3:1 bandwidth of the incoming RF frequency.

Finally, cos[(Ω−|ω₂−ω₁|)(t+T)] is the time-dependent term where the incoming RF frequency Ω has been shifted to the intermediate frequency Ω−|ω₂−ω₁|. The frequency shift from RF to IF provides for convenient processing of the link output in electrical domain that may include the digitization of the signal at a reduced frequency.

### Applications

The PHH link may be used in application requiring the delivery of high-frequency signals, which are to be further processed in electrical domain. As such, it may be used as a stand-alone, or point-to-point, link between a remote radio head and the base station of a radio-frequency receiver. The simplicity of the radio head that includes the minimum number of components and adjustments makes the solution particularly appealing for situations where the receiving antenna is in a hard-to-access location that may be subject to harsh environmental conditions.

The one-to-one link may be expanded to multiple remote radio heads to form a distributed-array receiver. In this case, the multiple radio heads may be placed at various locations and the optical fibers communicating with them gathered at a base station. The detected IF signals may be digitized and the RF beams may be formed in digital domain to take advantage of the diversity in the scattering environment for spatial division multiplexing and the increase of wireless network capacity for communication, or for the spatial location of RF sources in the environment. In this configuration, the optical links between different remote radio heads need not be coherent since the optical signals are converted to electrical domain before the beam-space processing takes place.

If the placement of the radio heads is well controlled so as to form a well-defined RF aperture, including a sparse aperture, the PHH link may be part of an RF-photonic phased-array architecture. In this case, each of the radio heads, or the elements of the RF front end, may use the outputs of the same lasers to maintain optical coherence among the different optical channels serving the phased array. Beam forming takes place in analog optical domain using conventional optics, such as free-space optics or photonic integrated circuit(s) (PIC-(s)). To maintain coherence between the distinct optical channels, closed-loop phase locking may be implemented such as that employed in PSI's imaging radiometers or imaging receivers. Unbalanced MZI-s for homodyne detection may be placed either before or after the beam-forming optical processor. Different placements of the MZI may be implemented for different applications.

The PHH link may also be used in a transmitter (TX) configuration as shown inf FIG. 19. In this case a low input frequency Ω is converted to a higher frequency Ω−|ω₂−ω₁| suitable for free-space transmission. For this configuration to work effectively, the input frequency S) should be sufficiently high so that the frequency |ω₂−ω₁| is efficiently attenuated at the output.

As described above, the architecture of a photonic heterodyne link with homodyne detection (PHH link) may provide advantages over conventional links including remote-head simplicity, conversion of RF to IF, robustness, and flexibility—at the cost of introducing a second wavelength to the optical carrier. The link may find use in applications requiring the delivery of high frequency signals for processing in electrical domain including distributed- and phased-array receivers.

What is claimed is:

1. The novel antennas, arrays, transmitters, receivers, transceivers, components thereof, and related methods disclosed herein.
